(19) United States
(12) Patent Application Publication
(10) Pub. No.: US 2012/0169847 A1
(43) Pub. Date: Jul. 5, 2012

(54) ELECTRONIC DEVICE AND METHOD FOR PERFORMING SCENE DESIGN SIMULATION

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/220,716

(22) Filed: Aug. 30, 2011

(30) Foreign Application Priority Data
Dec. 30, 2010 (TW) 099146843

(51) Int. Cl. H04N 13/02; G06T 15/00

(52) U.S. Cl. 348/46; 345/419; 348/E13.074

(57) ABSTRACT

A method performs scene design simulation using an electronic device. The method obtains a scene image of a specified scene, determines edge pixels of the scene image, fits the edge pixels to a plurality of feature lines, and determines a part of the feature lines to obtain an outline of the scene image. The method further determines a vanishing point and a plurality of sight lines of the specified scene to create a 3D model of the specified scene, and adjusts a display status of a received virtual 3D image in the 3D model of the specified scene according to the vanishing point, the sight lines, and an actual size of the specified scene.

### BACKGROUND

1. Technical Field

Embodiments of the present disclosure relate to an electronic device and method for performing scene design simulation.

2. Description of Related Art

When a user needs to buy some furniture for his/her new house, he must estimate whether the size of the furniture matches the size of the space in the new house. However, it is inconvenient for the user because the estimation of the user may not be very accurate.

### BRIEF DESCRIPTION OF THE DRAWINGS

FIG. 1 is a block diagram of one embodiment of an electronic device including a scene design simulation system.

FIG. 2 is a block diagram of one embodiment of the scene design simulation system included in the electronic device of FIG. 1.

FIG. 3 is a flowchart of one embodiment of a method for performing scene design simulation using the electronic device in FIG. 1.

FIG. 4A and FIG. 4B are schematic diagrams of one embodiment of an operation interface of the electronic device in FIG. 1.

FIG. 5A is an exemplary schematic diagram of one embodiment of feature lines of an image of a specified scene in a 3D coordinate system of the specified scene.

FIG. 5B is an exemplary schematic diagram of one embodiment of an outline of the image of the specified scene in the 3D coordinate system of the specified scene.

FIG. 6 is an exemplary schematic diagram of one embodiment of a vanishing point and a plurality of sight lines.

FIG. 7 is an exemplary schematic diagram of setting an actual size of the specified scene in a 3D model of the specified scene.

FIG. 8 is an exemplary schematic diagrams of dragging a virtual 3D image of an object into the 3D model of the specified scene.

FIG. 9 is an exemplary schematic diagrams of moving the virtual 3D image of the object in the 3D model of the specified scene.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

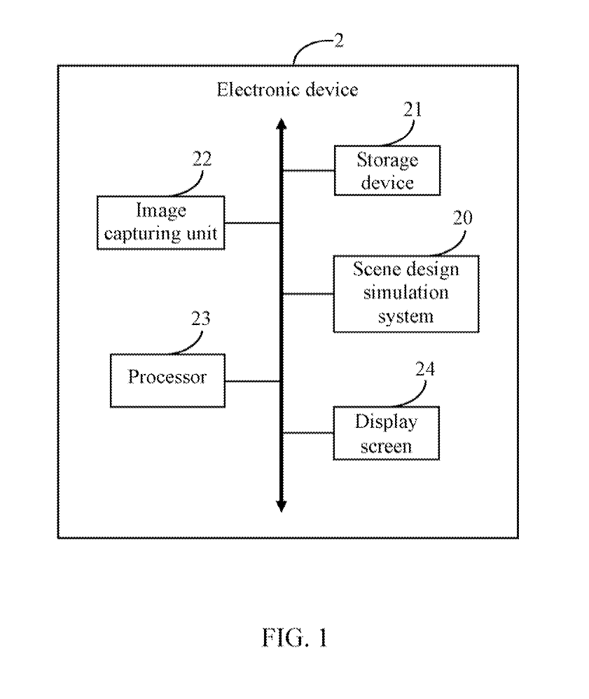

FIG. 1 is a block diagram of one embodiment of an electronic device 2 including a scene design simulation system 20. In one embodiment, the electronic device 2 further includes a storage device 21, an image capturing unit 22, at least one processor 23, and a display screen 24. The scene design simulation system 20 may be used to create a three dimensional (3D) model of a specified scene (e.g., a scene space of a room), and adjusts a display status of a virtual 3D image of an object (e.g., a sofa of the room) in the 3D model of the specified scene when the virtual 3D image of the object is moved in the 3D model of the specified scene. A detailed description will be given in the following paragraphs.

In one embodiment, the image capturing unit 22 is used to capture images of the specified scene (“scene images”), and store the scene images in the storage device 21. For example, the image capturing unit 22 may be a camera installed in the electronic device 2.

The display screen 24 may be a liquid crystal display (LCD) or a touch-sensitive display, for example. The electronic device 2 may be a mobile phone, a personal digital assistant (PDA) or any other suitable communication device.

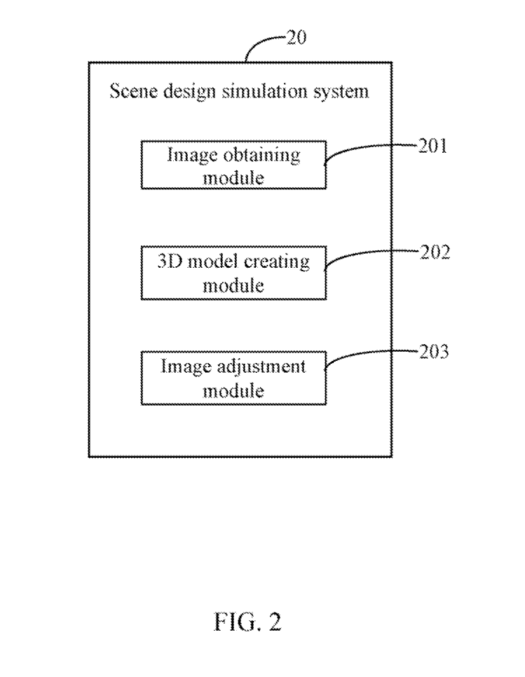

FIG. 2 is a block diagram of one embodiment of the scene design simulation system 20 in the electronic device 2. In one embodiment, the scene design simulation system 20 may include one or more modules, for example, an image obtaining module 201, a 3D model creating module 202, and an image adjustment module 203. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives. The one or more modules 201-203 may comprise computerized code in the form of one or more programs that are stored in the storage device 21 or memory of the electronic device 2. The computerized code includes instructions that are executed by the at least one processor 23 to provide functions for the one or more modules 201-203.

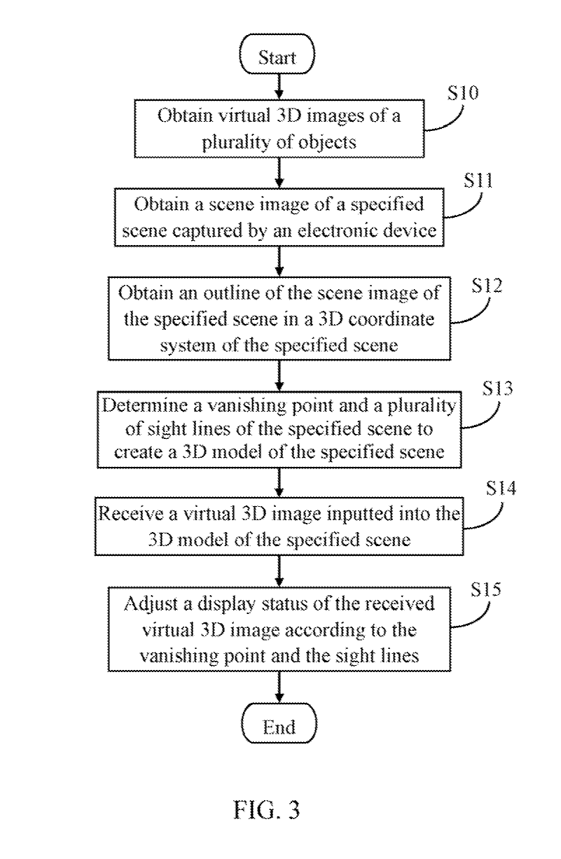

FIG. 3 is a flowchart of one embodiment of a method for performing scene design simulation using the electronic device 2 in FIG. 1. Depending on the embodiment, additional blocks may be added, others removed, and the ordering of the blocks may be changed.

In block S10, the image obtaining module 201 obtains virtual 3D images of a plurality of objects that have been drawn using a 3D image drawing tool (e.g., GOOGLE SketchUP). Then, the image obtaining module 201 stores the virtual 3D images of the objects, the actual sizes and colors of the object in the storage device 21. In one embodiment, the actual size of the object may include a length, a width, and a height of the object.

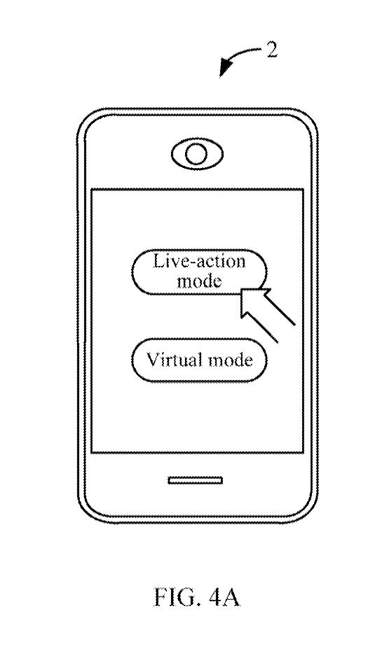

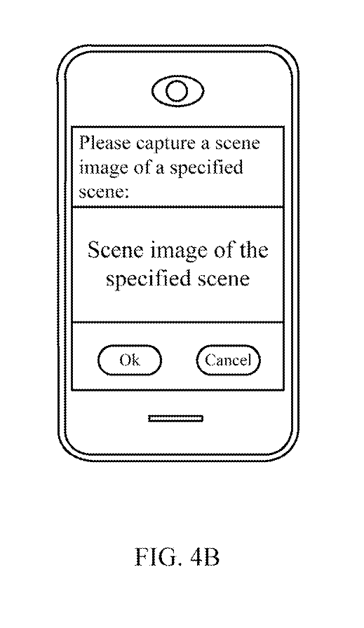

In block S11, the image obtaining module 201 obtains the image of the specified scene (“scene image”) captured by the image capturing unit 22 from the storage device 21 when a user selects a live-action mode as shown in FIG. 4A, and displays the scene image of the specified scene on the display screen 24. In embodiments, the live-action mode is defined as an image obtaining mode for capturing the image of the specified scene using a live-action photography. Refer to FIG. 4A, the user logs in the scene design simulation system 20 of the electronic device 2, selects the “live-action mode” button on the display screen 24 to enter an image capturing interface of FIG. 4B. In other embodiments, if the user selects a virtual mode in FIG. 4A, the image of the specified scene is a virtual image of a virtual scene.

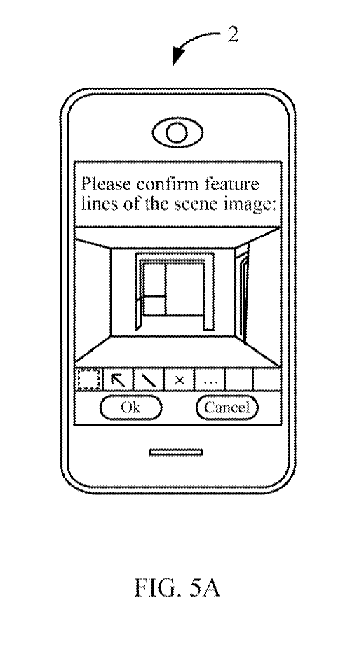

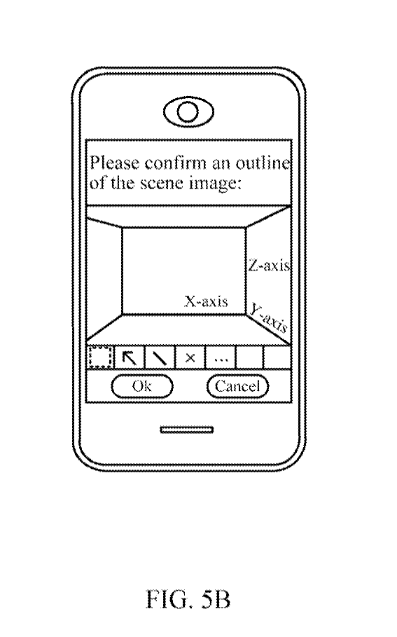

In block S12, the 3D model creating module 202 determines pixels of edges of the scene image (“edge pixels”) of the specified scene, fits the edge pixels to a plurality of feature lines, and determines a part of the feature lines to obtain an outline of the image of the specified scene in a three dimensional (3D) coordinate system of the specified scene. In one embodiment, the feature lines are determined using a Hough transform method or a fast generalized Hough transform method. An exemplary schematic diagram of the feature lines of the image of the specified scene is shown in FIG. 5A. An exemplary schematic diagram of the outline of the scene image of the specified scene is shown in FIG. 5B.

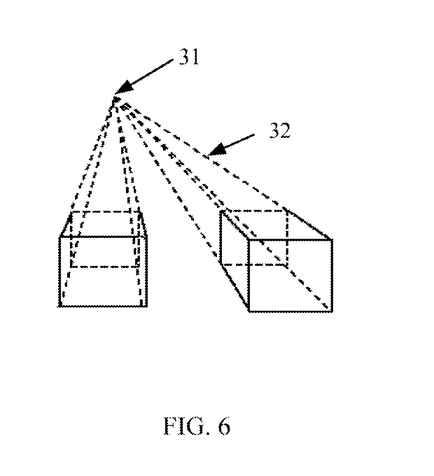

In block S13, the 3D model creating module 202 determines a vanishing point 31 and a plurality of sight lines 32 of the specified scene to create a 3D model of the specified scene on the display screen 24. In one embodiment, the vanishing point 31 and the sight lines 32 of the specified scene are determined using an one-point perspective method. An exemplary schematic diagram of the vanishing point 31 and the sight lines 32 is shown in FIG. 6.

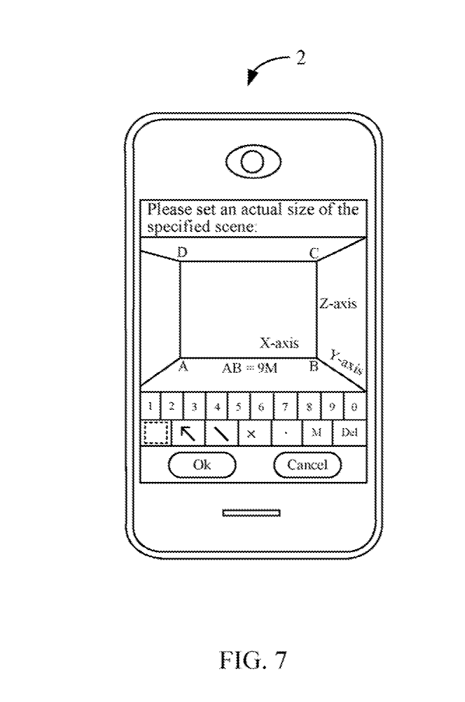

The 3D model creating module 202 receives the actual size of the specified scene set by the user when the 3D model of the specified scene is created. For example, as shown in FIG. 7, an actual length of the contour line “AB” in the specified scene is set as 9 meters (i.e., AB=9 m). It should be understood that the actual length of other contour lines may be determined according to the actual length of “AB”. For example, suppose that a ratio of AB:BC in FIG. 7 is 3:2, the actual length of the contour line “BC” is 6 meters.

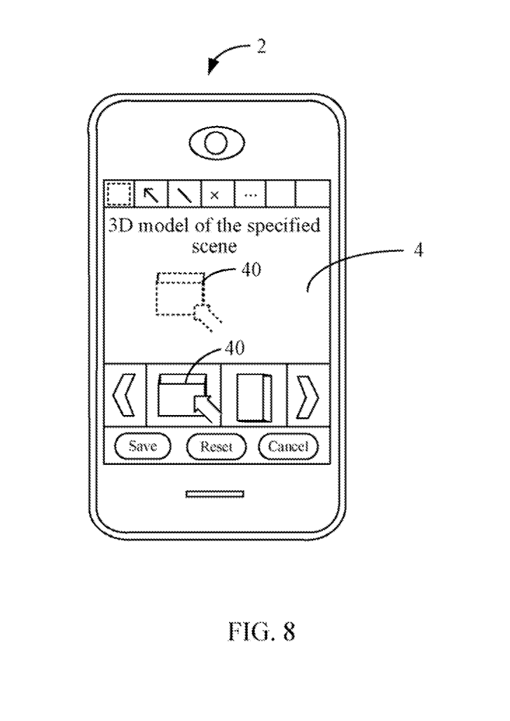

In block S14, the image adjustment module 203 receives a virtual 3D image of an object inputted into the 3D model of the specified scene. As shown in FIG. 8, a virtual 3D image 40 is dragged into the 3D model 4 of the specified scene using a finger of the user or a stylus.

In block S15, the image adjustment module 203 adjusts a display status of the virtual 3D image 40 in the 3D model 4 of the specified scene according to the vanishing point 31, the sight lines 32, and the actual size of the specified scene. A detailed description is as follows.

First, the image adjustment module 203 calculates a scaling factor between a length of a contour line in the outline of the scene image of the specified scene and an actual length of the contour line in the specified scene, and performs a zoom operation on the virtual 3D image of the object. For example, referring to FIG. 7, supposing that a length of the contour line “AB” in the image of the specified scene is 3 centimeters, the actual length of the contour line “AB” in the specified scene is 9 meters, the scaling factor is determined as 1/300. If the actual length of an object is 3 meters, the length of the virtual 3D image of the object in the 3D model of the specified scene is 1 cm.

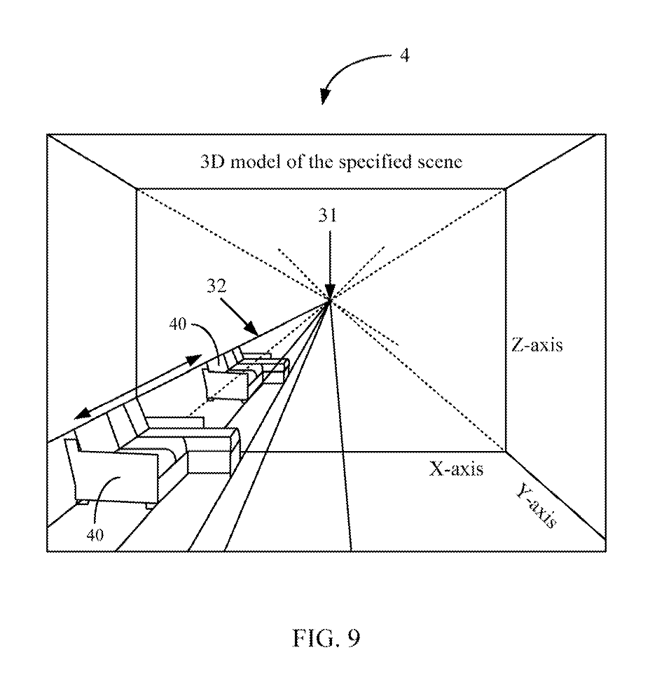

Second, the image adjustment module 203 performs automatic alignment of the virtual 3D image 40 of the object and the sight lines 32 of the specified scene (refers to FIG. 9).

Third, the image adjustment module 203 performs the zoom operation on the virtual 3D image of the object according to a distance between the virtual 3D image 40 and the vanishing point 31 when the virtual 3D image 40 is moved in the 3D model of the specified scene 4. For example, as shown in FIG. 9, if the virtual 3D image 40 is moved near to the vanishing point 31, the image adjustment module 203 performs a zoom out operation on the virtual 3D image 40 of the object. If the virtual 3D image 40 is removed from the vanishing point 31, the image adjustment module 203 performs a zoom in operation on the virtual 3D image 40 of the object.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for performing scene design simulation using an electronic device, the method comprising:
obtaining a scene image of a specified scene captured by an image capturing unit of the electronic device, and displaying the scene image on a display screen of the electronic device;
determining edge pixels of the scene image, fitting the edge pixels to a plurality of feature lines, and determining a part of the feature lines to obtain an outline of the scene image in a three dimensional (3D) coordinate system of the specified scene;
determining a vanishing point and a plurality of sight lines of the specified scene to create a 3D model of the specified scene;
receiving a virtual 3D image of an object inputted into the 3D model of the specified scene; and
adjusting a display status of the virtual 3D image in the 3D model of the specified scene according to the vanishing point, the sight lines, and an actual size of the specified scene.

2. The method according to claim 1, wherein the feature lines are determined using a Hough transform method or a fast generalized Hough transform method.

3. The method according to claim 1, wherein the vanishing point and the sight lines of the specified scene are determined using an one-point perspective method.

4. The method according to claim 1, wherein the step of adjusting a display status of the virtual 3D image in the 3D model of the specified scene comprises:
calculating a scaling factor between a length of a contour line in the outline of the scene image and an actual length of the contour line in the specified scene, and performing a zoom operation on the virtual 3D image of the object;
performing automatic alignment of the virtual 3D image of the object and the sight lines of the specified scene; and
performing the zoom operation on the virtual 3D image of the object according to a distance between the virtual 3D image and the vanishing point upon the condition that the virtual 3D image is moved in the 3D model of the specified scene.

5. The method according to claim 4, wherein the step of performing the zoom operation on the virtual 3D image of the object according to a distance between the virtual 3D image and the vanishing point comprises:
performing a zoom out operation on the virtual 3D image of the object upon the condition that the virtual 3D image is moved near to the vanishing point; or
performing a zoom in operation on the virtual 3D image of the object upon the condition that the virtual 3D image is removed from the vanishing point.

6. An electronic device, comprising:
a display screen;
a storage device;
an image capturing unit;
at least one processor; and
one or more modules that are stored in the storage device and are executed by the at least one processor, the one or more modules comprising instructions:
to obtain a scene image of a specified scene captured by the image capturing unit, and display the scene image on the display screen of the electronic device;
to determine edge pixels of the scene image, fit the edge pixels to a plurality of feature lines, and determine a part of the feature lines to obtain an outline of the scene image in a three dimensional (3D) coordinate system of the specified scene;
to determine a vanishing point and a plurality of sight lines of the specified scene to create a 3D model of the specified scene;
to receive a virtual 3D image of an object inputted into the 3D model of the specified scene; and
to adjust a display status of the virtual 3D image in the 3D model of the specified scene according to the vanishing point, the sight lines, and an actual size of the specified scene.

7. The electronic device according to claim 6, wherein the feature lines are determined using a Hough transform method or a fast generalized Hough transform method.

8. The electronic device according to claim 6, wherein the vanishing point and the sight lines of the specified scene are determined using an one-point perspective method.

9. The electronic device according to claim 6, wherein the instruction of adjusting a display status of the virtual 3D image in the 3D model of the specified scene comprises:
calculating a scaling factor between a length of a contour line in the outline of the scene image and an actual length of the contour line in the specified scene, and performing a zoom operation on the virtual 3D image of the object;
performing automatic alignment of the virtual 3D image of the object and the sight lines of the specified scene; and
performing the zoom operation on the virtual 3D image of the object according to a distance between the virtual 3D image and the vanishing point upon the condition that the virtual 3D image is moved in the 3D model of the specified scene.

10. The electronic device according to claim 9, wherein the instruction of performing the zoom operation on the virtual 3D image of the object according to a distance between the virtual 3D image and the vanishing point comprises:
performing a zoom out operation on the virtual 3D image of the object upon the condition that the virtual 3D image is moved near to the vanishing point; or
performing a zoom in operation on the virtual 3D image of the object upon the condition that the virtual 3D image is removed from the vanishing point.

11. A non-transitory storage medium having stored thereon instructions that, when executed by a processor of an electronic device, causes the processor to perform a method for performing scene design simulation using the electronic device, the method comprising:
obtaining a scene image of a specified scene captured by an image capturing unit of the electronic device, and displaying the scene image on a display screen of the electronic device;
determining edge pixels of the scene image, fitting the edge pixels to a plurality of feature lines, and determining a part of the feature lines to obtain an outline of the scene image in a three dimensional (3D) coordinate system of the specified scene;
determining a vanishing point and a plurality of sight lines of the specified scene to create a 3D model of the specified scene;
receiving a virtual 3D image of an object inputted into the 3D model of the specified scene; and
adjusting a display status of the virtual 3D image in the 3D model of the specified scene according to the vanishing point, the sight lines, and an actual size of the specified scene.

12. The non-transitory storage medium according to claim 11, wherein the feature lines are determined using a Hough transform method or a fast generalized Hough transform method.

13. The non-transitory storage medium according to claim 11, wherein the vanishing point and the sight lines of the specified scene are determined using an one-point perspective method.

14. The non-transitory storage medium according to claim 11, wherein the step of adjusting a display status of the virtual 3D image in the 3D model of the specified scene comprises:
calculating a scaling factor between a length of a contour line in the outline of the scene image and an actual length of the contour line in the specified scene, and performing a zoom operation on the virtual 3D image of the object;
performing automatic alignment of the virtual 3D image of the object and the sight lines of the specified scene; and
performing the zoom operation on the virtual 3D image of the object according to a distance between the virtual 3D image and the vanishing point upon the condition that the virtual 3D image is moved in the 3D model of the specified scene.

15. The non-transitory storage medium according to claim 14, wherein the step of performing the zoom operation on the virtual 3D image of the object according to a distance between the virtual 3D image and the vanishing point comprises:
performing a zoom out operation on the virtual 3D image of the object upon the condition that the virtual 3D image is moved near to the vanishing point; or
performing a zoom in operation on the virtual 3D image of the object upon the condition that the virtual 3D image is removed from the vanishing point.

16. The non-transitory storage medium according to claim 11, wherein the medium is selected from the group consisting of a hard disk drive, a compact disc, a digital video disc, and a tape drive.
